(19) United States
(12) Patent Application Publication
(10) Pub. No.: US 2013/0304338 A1
(43) Pub. Date: Nov. 14, 2013

(54) CLUTCH CONTROL SYSTEM FOR PAVER

(71) Applicant: Toby A. Frelich, Saint Michael, MN (US)

(72) Inventor: Toby A. Frelich, Saint Michael, MN (US)

(73) Assignee: Caterpillar Paving Products Inc., Minneapolis, MN (US)

(21) Appl. No.: 13/467,130

(22) Filed: May 9, 2012

(51) Int. Cl. F16D 48/00

(52) U.S. Cl. 701/67

(57) ABSTRACT

A clutch control system for a clutch provided between an engine and a load drive. The clutch control system includes a sensor, a detector, an electronic control module and a controller. The sensor is configured to determine a running condition of an engine, and generate a load signal indicative of the running condition of the engine. The detector is associated with an operator control for a load drive to sense an issuance of a work command by the operator control to the load drive, and generate a command signal on issuance of the work command. The electronic control module is configured to receive and process the load signal and the command signal, and generate a control signal according to the load signal and the command signal. Further, the controller is configured to selectively engage or disengage the clutch according to the control signal.

### TECHNICAL FIELD

The present disclosure relates to a clutch provided between an engine and a load drive in a paver, and more particularly to a clutch control system for the clutch.

### BACKGROUND

A machine, such as, a paver employs a load drive to power various systems perform different operations in the machine. Generally, the load drive performs these operations on expense of power supplied from an engine. It may be desired that the load drive may be decoupled from the engine during certain conditions, and particularly during a cold-start of the engine. However, when the machine is required to perform operations, the load drive is required to be coupled back with the engine to draw power from thereof.

Generally, the machine includes a clutch which may be engaged or disengaged to couple or de-couple the engine and the load drive, respectively. Conventional clutches are required to be controlled by the operator of the machine. US Patent Application No. 20100296866 discloses a paver including a combustion engine. The paver includes functional units having hydraulic pumps which can be driven by the combustion engine, for example, a travel drive with at least one pump, a generator, etc. associated with the paver. The generator is driven permanently while at least one pump can be selectively disconnected from the combustion engine via a clutch. Particularly, the clutch is disconnected for at least one of the pumps, during a heating-up phase of electric heating devices via the permanently driven generator or during warm-up of the combustion engine, by the operator.

### SUMMARY

In one aspect, the present disclosure provides a clutch control system for a clutch provided between an engine and a load drive. The clutch control system includes a sensor, a detector, an electronic control module and a controller. The sensor is configured to determine a running condition of an engine, and generate a load signal indicative of the running condition of the engine. The detector is associated with an operator control for a load drive to sense an issuance of a work command by the operator control to the load drive, and generate a command signal on the issuance of the work command. The electronic control module is configured to receive and process the load signal and the command signal, and generate a control signal according to the load signal and the command signal. Further, the controller is configured to selectively engage or disengage the clutch according to the control signal.

In another aspect, the present disclosure provides a paver including the engine configured to output power through a crankshaft and the load drive adapted to be driven by the crankshaft of the engine. Further, the paver includes the operator control to issue a work command for the load drive. The clutch is provided to drivingly couple the crankshaft of the engine and the load drive. The paver includes the clutch control system having the sensor, the detector, the electronic control module and the controller. The sensor is configured to determine the running condition of an engine, and generate the load signal indicative of the running condition of the engine. The detector is associated with the operator control for the load drive to sense the issuance of a work command by the operator control to the load drive, and generate the command signal on the issuance of the work command. The electronic control module is configured to receive and process the load signal and the command signal, and generate the control signal according to the load signal and the command signal. Further, the controller is configured to selectively engage or disengage the clutch according to the control signal.

In yet another aspect, the present disclosure provides a method for controlling the clutch. The method includes sensing the running condition of the engine, and generating the load signal according to the running condition of the engine. The method further includes detecting the issuance of the work command for the load drive, and generating the command signal on the issuance of the work command. The method further includes receiving the command signal and the load signal, and processing the command signal and the load signal, and generating the control signal according to the command signal and the load signal. Finally, the method includes selectively engaging or disengaging the clutch according to the control signal.

Other features and aspects of this disclosure will be apparent from the following description and the accompanying drawings.

### BRIEF DESCRIPTION OF THE DRAWINGS

FIG. 1 illustrates a perspective view of a paver, according to an aspect of the present disclosure;

FIG. 2 illustrates a schematic block diagram of the paver of FIG. 1 with a clutch control system, according to an aspect of the present disclosure; and

FIG. 3 illustrates a process flow for controlling a clutch, according to another aspect of the present disclosure.

### DETAILED DESCRIPTION

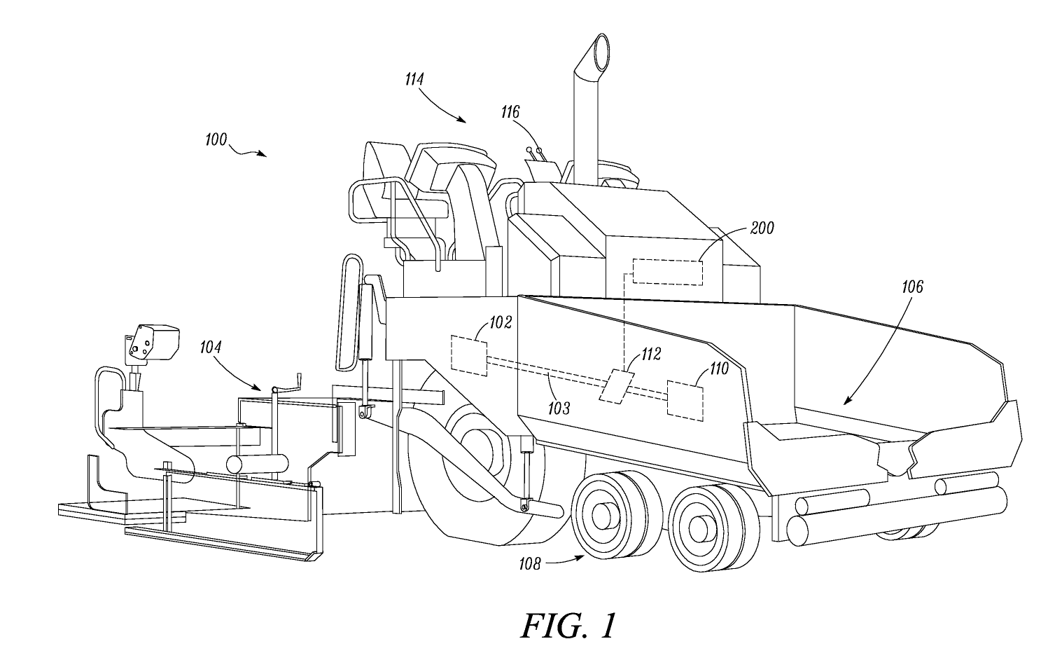

The present disclosure relates to systems and methods to control a clutch between a power source and a load drive in a machine. The present disclosure will now be described in detail with reference being made to accompanying figures. A machine in which disclosed embodiments may be implemented is illustrated in FIG. 1. The machine may be generically described as any machine which includes a power source, such as, an engine to power a load drive, in order to perform various operations associated with, for example, but not limited to, industries such as mining, construction, farming, transportation, or the like.

The present disclosure has been described here in view of the machine embodied as a paver 100. Herein after, the machine and the paver 100 have been interchangeably used to describe the present disclosure. The paver 100 of the present disclosure includes an engine 102 to power the various components. The engine 102 may be any internal combustion engine, such as, a gasoline, diesel or natural gas engine, etc. Further, the engine 102 may include a number of cylinders arranged in any suitable configuration, for example, in-line arrangement, “V” arrangement, radial arrangement, or the like. The engine 102 may be configured to output power, for other components in the paver 100, via a crankshaft 103.

The paver 100 may further include various systems, such as, a screed assembly 104, a material feed system 106, a propel system 108, etc., configured to perform different operations in the paver 100. For example, the screed assembly 104 may be configured to lay and level a mix of concrete, asphalt or plaster. Further, the material feed system 106 may include one or more conveyors and augers to deliver the mix to the screed assembly 104. The propulsion system 108 may include one or more propel motors associated with drive wheels or tracks, and provide the propulsion for the paver 100. Generally, these systems 104, 106, 108 utilize one or more hydraulic pumps and/or one or more electric or hydraulic motors to achieve the purpose.

The paver 100 of the present disclosure includes a load drive 110 to power the systems 104, 106, 108. The load drive 110 may be operatively connected to the engine 102, and works on expense of power generated by the engine 102. It may be apparent to a person having ordinary skill in the art that, the load drive 110 may be one or combination of a hydrostatic drive, an electric drive or an electro-hydraulic drive, having a pump and/or a generator to provide hydraulic and/or electrical power, respectively, according to requirements of the systems 104, 106, 108 in the paver 100. In an exemplary configuration, the load drive 110 may include a pump, powered by the engine 102, to pressurize a hydraulic fluid, which in turn is dispersed via valves to drive some secondary pumps in the systems 104, 106, 108 of the paver 100. In other example, the load drive 110 may include a generator, which converts the mechanical power of the engine to generate electric power to be used by motors in the systems 104, 106, 108 of the paver 100.

The paver 100 may further include an operator control 114 for operating the load drive 110. In an embodiment, the operator control 114 may be provided in an operator cab or a station of the paver 100, and include one or more operator input devices 116 for an operator. The one or more operator input devices 116 may be in the form of joy-sticks, levers, key-boards, touch screen displays, or the like. The one or more operator input devices 116 may be adapted to receive input from the operator indicative of a desired output from the load drive 110.

In an embodiment, the load drive 110 may be drivingly coupled to the crankshaft 103 of the engine 102, via a clutch 112. It may be understood that the clutch 112 may be configured to couple and de-couple the engine 102 and the load drive 110, in an engaged and dis-engaged position respectively. The clutch 112 may be, but not limited to, a hydraulic clutch, an electromagnetic clutch, a pneumatic clutch, a hysteresis clutch, a powered-mechanical clutch, etc. For example, the clutch 112 may be a hydraulic clutch having one or more valves movable between actuated and un-actuated positions, and the clutch 112 may be engaged or disengaged by moving these valves under pressure of some hydraulic fluid provided by a pump. Further, according to an embodiment of the present disclosure, the paver 100 includes a clutch control system 200.

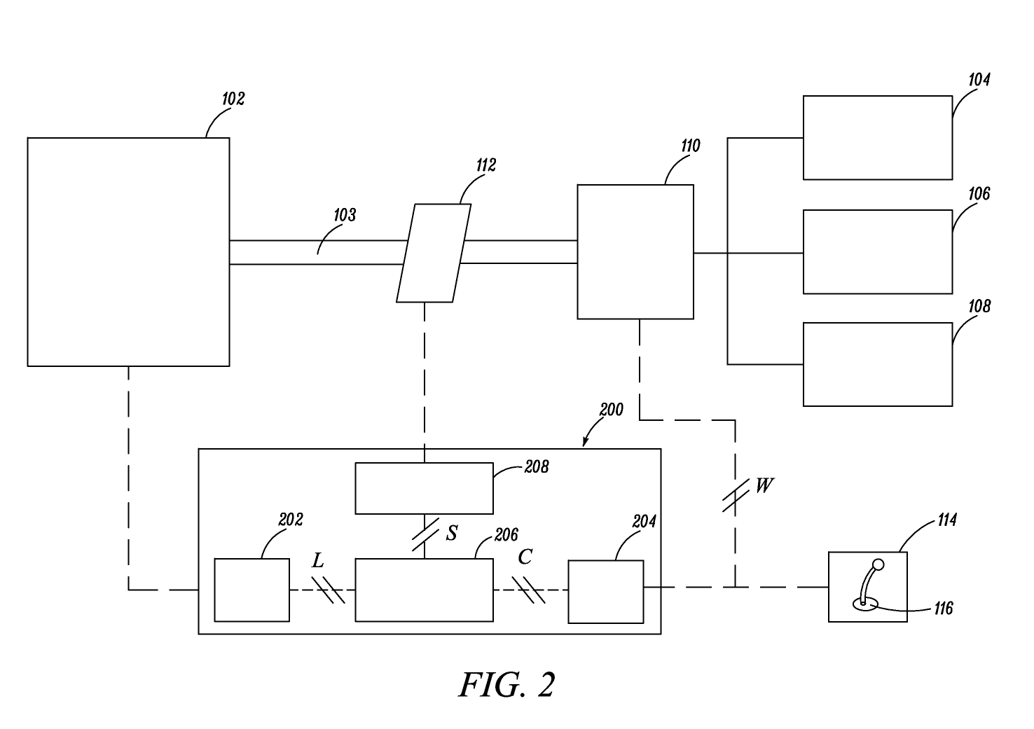

FIG. 2 illustrates a schematic block diagram of the paver 100, showing the clutch control system 200 in association with other components of the paver 100. The clutch control system 200 of the present disclosure includes a sensor 202, a detector 204, an electronic control module 206, and a controller 208, working in conjunction to control the clutch 112.

As illustrated in FIG. 2, the sensor 202 may be operatively associated with the engine 102. The sensor 202 may be configured to determine a running condition of the engine 102, in the paver 100. In an embodiment, the sensor 202 may be configured to determine a start condition and a load operating condition, of the running condition of the engine 102. The sensor 202 may achieve this by monitoring the ignition, cranking, loads, temperatures or the like, of the engine 102 in the paver 100. The sensor 202 may further be configured to generate a load signal L, indicative of the running condition of the engine 102, and pass the load signal L to the electronic control module 206 of the clutch control system 200.

Further, the detector 204 may be associated with the operator control 114, to detect movement of the operator input devices 116 of the operator control 114. The detector 204 may be configured to detect an issuance of a work command W, by the operator control 114 for the load drive 110. In an embodiment, the detector 204 may be a magneto-resistive sensor, an interferometer, an optical encoder, a photo-reflective sensor, or the like, which reads some markings or patterns to determine the movement of the operator input devices 116. The detector 204 may further be configured to generate a command signal C on sensing the issuance of the work command W, and pass the generated command signal C to the electronic control module 206 of the clutch control system 200.

The electronic control module 206 may be operatively connected to the sensor 202 and the detector 204, in the clutch control system 200. The electronic control module 206 may be configured to receive the load signal L and the command signal C, from the sensor 202 and the detector 204, respectively. The electronic control module 206 may further be configured to process the load signal L and the command signal C, to generate a control signal S according to control logic. For example, the electronic control module 206 of the present disclosure generates the control signal S for engagement of the clutch 112, when the engine 102 is in the load operating condition and the command signal C is received. In other scenarios, the electronic control module 206 may generate the control signal S for dis-engagement of the clutch 112. It may be apparent that the electronic control module 206 may include a set of instructions, a Random Access Memory (RAM), a Read Only Memory (ROM), a flash memory, a data structure, and the like, to achieve the purpose.

Further, the controller 208 may be disposed in connection with the electronic control module 206, in the clutch control system 200. The controller 208 may be configured to receive the control signal S, and selectively engage the clutch 112 according to the control signal S. It may be apparent to a person skilled in the art that, the control signal S may control a current supplied to actuate some solenoid valve, hydraulic valve or the like associated with the clutch 112, which in turn defines the engagement or disengagement of the clutch 112.

In an exemplary embodiment, the paver 100 may further include a generator (not illustrated) operatively connected to the engine 102. The generator may be disposed between the engine 102 and the load drive 110, or on a separate line. The generator may convert the mechanical energy of the engine 102 to electrical energy to drive various electrical systems, for example, a screed heating system of the screed assembly 104, in the paver 100. Further, in an embodiment, this electrical energy may be used for actuation of the clutch 112, in case of the clutch 112 being the electro-magnetic clutch or the like.

### INDUSTRIAL APPLICABILITY

The industrial applicability of the systems and methods for controlling the clutch 112, described herein will be readily appreciated from the foregoing discussion. Although, the disclosure has been described in terms of the paver 100, the systems and methods described herein may be adapted to a large variety of machines and tasks. For example, a planar, a material handler, a harvester, and many other machines may benefit from the systems and methods described herein.

Machine, such as a paver, employs the load drive, using power from the engine, to run systems/implements, such as, the material handling system, the material feed system, the propel system, the screed heating system, etc. Because of the load drive constantly drawing some power, the paver may have complications during cold-start of the engine. Further, this may lead to additional fuel consumption even in case of no work being done by the load drive, because of the load drive being coupled to the engine. To overcome these issues, a clutch is provided to couple or de-couple the engine and the load drive. Conventional clutches are controlled manually and therefore require the input from the operator.

The present disclosure provides the clutch control system 200 for the paver 100. The clutch control system 200 uses the sensor 202 and the detector 204, to sense the running condition of the engine 102 and the issuance of the work command W, respectively, and generate the command signal C and the load signal L, in the process. The electronic control module 206 processes the command signal C and the load signal L, and generate the control signal S for the controller 208. In an embodiment, the controller 208 varies the current supplied to the actuation means for the clutch 112, and therefore able to selectively engage the clutch 112.

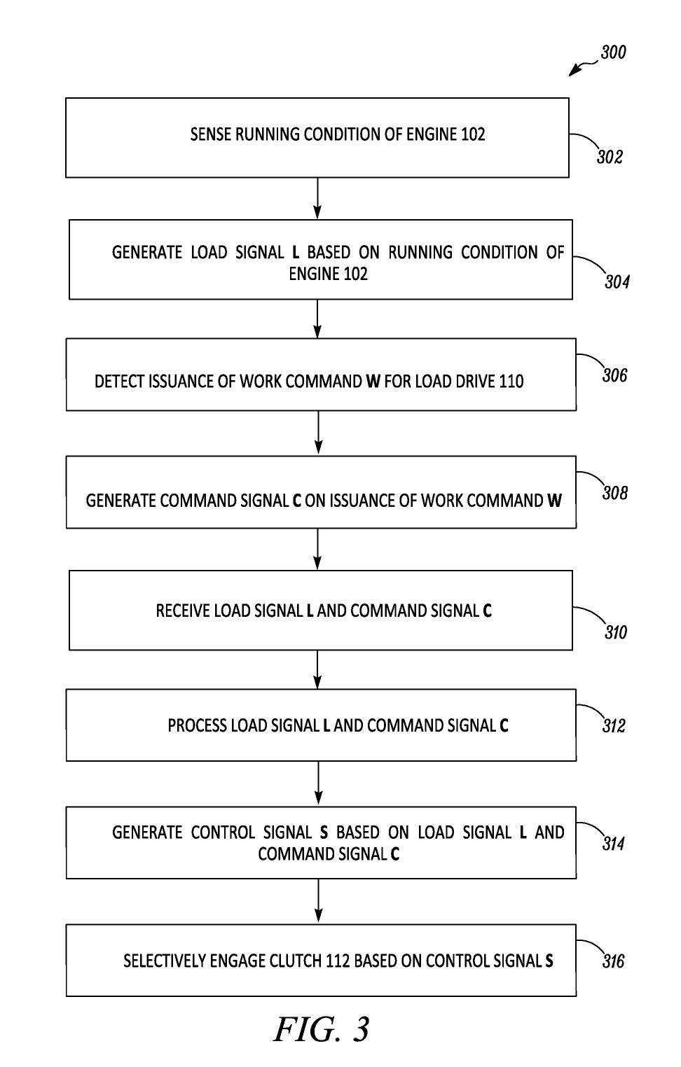

The present disclosure further provides a method for controlling the clutch 112. FIG. 3 illustrates a process flow 300 depicting the various steps required for the purpose. In step 302, the process flow 300 involves determining the running condition of the engine 102. Further, in step 304, the process flow 300 involves generating the load signal L according to the determined running condition of the engine 102. Subsequently, in step 306, the process flow 300 involves sensing the issuance of the work command W for the load drive 110, and step 308 involves generating the command signal C on the issuance of the work command W. Further, in step 310, the process flow 300 involves receiving the load signal L and the command signal C. In step 312, the process flow 300 involves processing the load signal L and the command signal C. Subsequently, in step 314, the process flow 300 involves generating the control signal S according to the load signal L and the command signal C. Finally, in step 316, the process flow 300 involves selectively engaging the clutch 112 according to the control signal S.

Generally, the clutch 112 in the paver 100 is in the disengaged position, for most of the times. The controller 208 is configured to engage the clutch 112 when the load signal L indicates the operating load condition of the engine 102, and the command signal C is generated. Further, the controller 208 is configured to disengage the clutch 112 when the load signal L indicates the starting condition of the engine 102 and/or in case of no command signal C. Thus, the current clutch control system 200 allows for the clutch 112 to be in the engaged position, for power transfer from the engine 102 to the load drive 110, when the engine 102 is in the load operating condition, as determined by the sensor 202 and the work command W has been issued, as detected by the detector 204.

Therefore, the clutch control system 200 ensures that the load drive 110 may be drawing power from the engine 102, only when the systems 104, 106, 108 are required to perform some operations, as desired by the operator. The clutch control system 200 may disengage the clutch 112 in case of no work command W, and thus helps to limit the power transfer from the engine 102 to the load drive 110. This may result in lower fuel consumption by the engine 102, and therefore significant cost savings in operation of the paver 100.

Further, the clutch control system 200 may help in cold-starting of the engine 102. This is achieved, as the sensor 202 determines the starting condition of the engine 102, the controller 208 may disengage the clutch 112. Thus, the load drive 110 is de-coupled from the engine 102, and the engine 102 may be easily started because of significantly reduced load. Further, once the detector 204 detects the issuance of the work command W, the clutch 112 is engaged back to power the load drive 110 to perform relevant operations in the paver 100.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended and will be appreciated that the specification and examples be considered as exemplary only, with a true scope being indicated by the following claims and their equivalents.

What is claimed is:

1. A clutch control system for a clutch provided between an engine and a load drive, the clutch control system comprising:
a sensor associated with the engine, the sensor configured to sense a running condition of the engine, and generate a load signal indicative of the running condition of the engine;
a detector associated with an operator control for the load drive, the detector configured to detect an issuance of a work command by the operator control to the load drive, and generate a command signal on the issuance of the work command;
an electronic control module configured to receive and process the load signal and the command signal, and generate a control signal according to the load signal and the command signal; and
a controller configured to selectively engage the clutch according to the control signal.

2. The clutch control system of claim 1, wherein the sensor is configured to determine a starting condition and a load operating condition, of the running condition of the engine.

3. The clutch control system of claim 1, wherein the detector is configured to sense the issuance of the work command according to positions of operator input devices of the operator control.

4. The clutch control system of claim 2, wherein the controller is configured to selectively engage the clutch in case of the load operating condition of the engine.

5. The clutch control system of claim 2, wherein the controller is configured to disengage the clutch in case of the starting condition of the engine.

6. A paver comprising:
an engine configured to output power through a crankshaft;
a load drive adapted to be driven by the crankshaft of the engine;
an operator control configured to issue a work command for the load drive;
a clutch adapted to drivingly couple the crankshaft of the engine and the load drive; and
a clutch control system including:
a sensor associated with the engine, the sensor configured to sense a running condition of the engine, and generate a load signal indicative of the running condition of the engine;
a detector associated with the operator control for the load drive, the detector configured to detect the issuance of the work command, and generate a command signal on the issuance of the work command;
an electronic control module configured to receive and process the load signal and the command signal, and generate a control signal according to the load signal and the command signal; and
a controller configured to selectively engage the clutch according to the control signal.

7. The paver of claim 6 further includes at least one of a screed assembly, a material feed system, and a propel system.

8. The paver of claim 7, wherein the load drive is configured to run at least one of the screed assembly, the material feed system, and a propel system, utilizing power from the engine.

9. The paver of claim 6, wherein the load drive is one of a hydrostatic drive, an electric drive, or an electro-hydraulic drive.

10. The paver of claim 6, wherein the clutch is any one of an electromagnetic clutch, a hydraulic clutch and a pneumatic clutch.

11. The paver of claim 6, wherein the sensor is configured to determine a starting condition and a load operating condition, of the running condition of the engine.

12. The paver of claim 6, wherein the detector is configured to sense the issuance of the work command according to positions of operator input devices of the operator control.

13. The paver of claim 11, wherein the controller is configured to engage the clutch in case of the load operating condition of the engine.

14. The paver of claim 11, wherein the controller is configured to disengage the clutch in case of the starting condition of the engine.

15. A method for controlling a clutch, provided between an engine and a load drive, the method comprising:
sensing a running condition of the engine;
generating a load signal according to the running condition of the engine;
detecting an issuance of a work command for the load drive;
generating a command signal on the issuance of the work command;
receiving the load signal and the command signal;
processing the load signal and the command signal;
generating a control signal according to the load signal and the command signal; and
selectively engaging the clutch according to the control signal.

16. The method of claim 15, wherein sensing the running condition of the engine includes determining whether the engine is in a staring condition or a load operating condition.

17. The method of claim 15, wherein detecting the issuance of work command includes providing a sensor in association with operator input devices in an operator control, for the load drive.

18. The method of claim 17, wherein detecting the issuance of work command further includes sensing a position of control means in the operator control for the load drive.

19. The method of claim 16, wherein selectively engaging the clutch includes engaging the clutch in case of sensing the load operating condition of the engine and detecting the issuance of the work command.
